(19) United States
(12) Patent Application Publication
(10) Pub. No.: US 2008/0118634 A1
(43) Pub. Date: May 22, 2008

(54) METHOD FOR MANUFACTURING TRANSPARENT CONDUCTIVE FILM

(75) Inventors: YANG WEI, Beijing (CN); LIN XIAO, Beijing (CN); FENG ZHU, Beijing (CN); LIANG LIU, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/875,104

(22) Filed: Oct. 19, 2007

(30) Foreign Application Priority Data
Nov. 22, 2006 (CN) 200610157000.8

(51) Int. Cl. B05D 5/12

(52) U.S. Cl. 427/108; 977/742

(57) ABSTRACT

A method for manufacturing a transparent conductive film on a glass structure, the method including the steps of: preparing a carbon nanotube slurry; applying a carbon nanotube slurry layer onto the glass structure; drying the carbon nanotube slurry layer on the glass structure; and solidifying the carbon nanotube slurry layer on the glass structure at an approximate temperature of 300˜500° C. and under protection of an inert gas, in order to form the transparent conductive film on the glass structure.

### CROSS-REFERENCE TO RELATED APPLICATIONS

This application is related to a commonly-assigned co-pending application entitled, “Method for Manufacturing Field Emission Electron Source”, filed on Oct. 5, 2007 (Atty. Docket No. US12421). Disclosure of the above-identified application is incorporated herein by reference.

### BACKGROUND

1. Field of the Invention

The present invention relates to methods for manufacturing transparent conductive films and, particularly, to a method for manufacturing a transparent conductive film on a glass structure.

2. Description of Related Art

Transparent conductive films are used widely in field emission displays, liquid crystal displays, solar cells, etc. Generally, an electrode used in a field emission device includes a substrate and a conductive film formed on the substrate. As for anodes, the conductive film is transparent and is formed on a transparent substrate, and a phosphor layer is formed on the transparent conductive film. As for cathodes, the conductive film is formed on a cathode substrate, and an electron-emission layer is formed on the conductive film. The anode and the cathode are oppositely configured to produce a spatial electrical field when a voltage is applied therebetween. Electrons are emitted from the electron-emission layer toward the phosphor layer. The phosphor layer is excited by the electrons to emit light. Light can be transmitted out of the field emission device, due to transparency of the conductive film and the transparent substrate.

Nowadays, the transparent conductive film is typically an indium-tin-oxide (ITO) film. The ITO film is formed on the substrate by a process of magnetron sputtering. However, manufacturing steps in this process are complex and materials used in this process are expensive.

What is needed, therefore, is a transparent conductive film and a related method for manufacturing such film, in which the above problems are eliminated or at least alleviated.

### SUMMARY

In a present embodiment, a method for manufacturing a transparent conductive film on a glass structure includes the steps of: preparing a carbon nanotube slurry; applying a carbon nanotube slurry layer onto the glass structure; drying the carbon nanotube slurry layer on the glass structure; and solidifying the carbon nanotube slurry layer on the glass structure at an approximate temperature of 300˜500° C. and under protection of an inert gas, in order to thereby form the transparent conductive film on the glass structure.

Advantages and novel features will become more apparent from the following detailed description of the present method for manufacturing a transparent conductive film, when taken in conjunction with the accompanying drawings.

### BRIEF DESCRIPTION OF THE DRAWINGS

Many aspects of the present method for manufacturing a transparent conductive film can be better understood with reference to the following drawings. The components in the drawings are not necessarily drawn to scale, the emphasis instead being placed upon clearly illustrating the principles of the present method for manufacturing a transparent conductive film. Moreover, in the drawings, like reference numerals designate corresponding parts throughout the several views.

FIG. 1 is a flow chart of a method for manufacturing a transparent conductive film on a glass structure, according to a present embodiment; and

FIG. 2 is a flow chart of a method for preparing the carbon nanotube slurry, according to the present embodiment.

Corresponding reference characters indicate corresponding parts throughout the drawings. The exemplifications set out herein illustrate at least one preferred embodiment of the present method for manufacturing a transparent conductive film, in one form, and such exemplifications are not to be construed as limiting the scope of the invention in any manner.

### DETAILED DESCRIPTION OF THE INVENTION

Reference will now be made to the drawings to describe at least one present embodiment of the method for manufacturing a transparent conductive film.

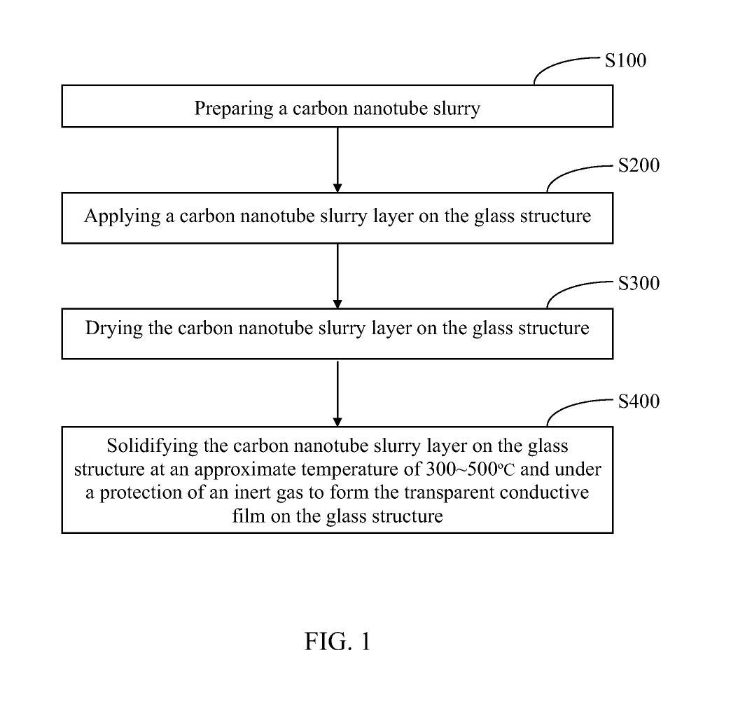

Referring to FIG. 1, a method for manufacturing a transparent conductive film on a glass structure, according to a present embodiment, is shown. The method includes the steps of:

preparing a carbon nanotube slurry, shown as step S100;
applying a carbon nanotube slurry layer on the glass structure, shown as step S200; drying the carbon nanotube slurry layer on the glass structure, shown as step S300; and solidifying the carbon nanotube slurry layer on the glass structure at an approximate temperature of 300˜500° C. and under a protection of an inert gas (e.g., N, Ar, He), in order to form the transparent conductive film on the glass structure, shown as step S400.

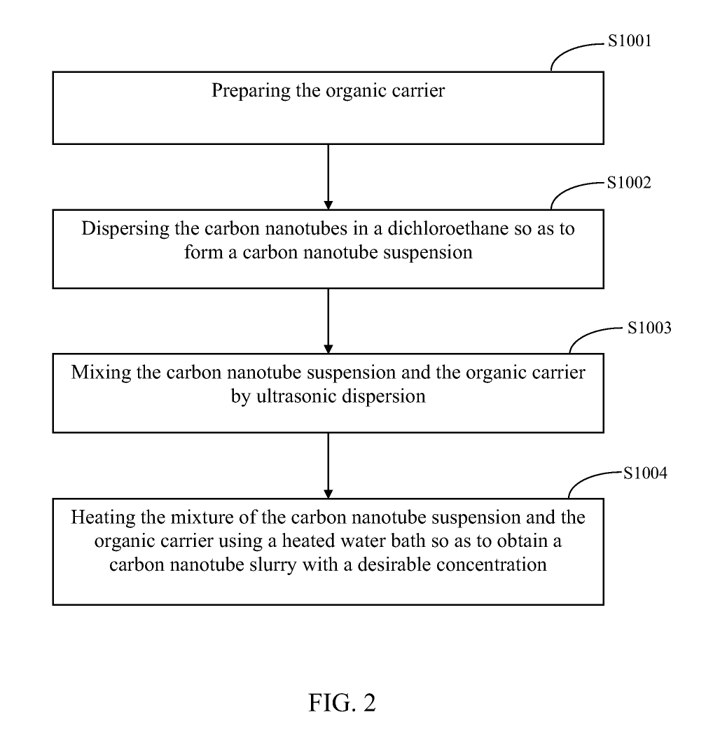

In step S100, the carbon nanotube slurry typically includes an organic carrier and a plurality of carbon nanotubes suspended in the organic carrier. Referring to FIG. 2, a method for preparing the carbon nanotube slurry includes the steps of: preparing the organic carrier, shown as step S1001; dispersing the carbon nanotubes in dichloroethane so as to form a carbon nanotube suspension, shown as step S1002; mixing the carbon nanotube suspension and the organic carrier using ultrasonic dispersion, shown as step S1003; and heating the mixture of the carbon nanotube suspension and the organic carrier using a heated water bath so as to obtain a carbon nanotube slurry with a desirable concentration, shown as step S1004.

In step S1001, the organic carrier advantageously includes at least one of terpineol, dibutyl phthalate, and ethyl cellulose and, most suitably, constitutes a mixture of such components. A method for preparing the organic carrier includes the steps of: dissolving ethyl cellulose and then dibutyl phthalate into terpilenol at about a temperature of 80 to 110° C., quite suitably about 100° C., using a heated oil bath; and, upon reaching and holding a temperature of about 80˜110° C., stirring the mixture of ethyl cellulose, dibutyl phthalate, and terpilenol for about 10˜25 hours, quite usefully about 24 hours.

The terpineol acts as a solvent, the dibutyl phthalate acts as a plasticizer, and the ethyl cellulose acts as a stabilizer. Opportunely, percentages of weights of ingredients of the organic carrier are about 90% of terpilenol, about 5% of ethyl cellulose, and about 5% of dibutyl phthalate.

In the step S1002, the carbon nanotubes are manufactured by a process selected from the group consisting of CVD (chemical vapor deposition), arc discharge, and laser ablation. A length of the carbon nanotubes should, rather advantageously, be in the approximate range from 1 to 500 microns, (most advantageously about 10 microns) and a diameter of the carbon nanotubes should beneficially be in the approximate range from 1 to 100 nanometers. A ratio of carbon nanotubes to dichloroethane is, opportunely, about two grams of carbon nanotubes per about 500 milliliters of dichloroethane. The dispersing step rather suitably includes crusher-dispersing and then ultrasonic-dispersing. Crusher-dispersing should take from about 5˜30 minutes and should quite usefully take about 20 minutes. Meanwhile, the ultrasonic-dispersing should take from about 10˜40 minutes and rather suitably should take about 30 minutes.

Furthermore, after the dispersing step, a mesh screen is used to filter the carbon nanotube suspension so that desirable carbon nanotubes can be collected. The number of the sieve mesh of the screen should, rather usefully, be about 400.

In the step S1003, a weight ratio of carbon nanotubes to the organic carrier is 15 to 1; a duration of ultrasonic dispersion is 30 minutes.

In the step S1004, beneficially, a temperature of the water bath used for the heating step is about 90° C., so as to obtain a carbon nanotube slurry with a desirable concentration.

Transparency and conductivity of the carbon-nanotube-based transparent conductive film depend, in large part, on the concentration of the carbon nanotubes in the carbon nanotube slurry. If the concentration of the carbon nanotubes is relatively high, the transparency of the resultant transparent conductive film is relatively low, while the conductivity of such a transparent conductive film is relatively high. If the concentration of the carbon nanotubes is, instead, relatively low, the transparency of the resultant transparent conductive film is relatively high, while the conductivity thereof is relatively low. In this present embodiment, about 2 grams of carbon nanotubes are used per about 500 milliliters of dichloroethane, and, accordingly, a weight ratio of carbon nanotubes to the organic carrier is about 15 to 1.

In the step S200, if the glass structure is a glass plate, a method for applying a carbon nanotube slurry layer onto the glass plate usefully includes providing two stacked glass plates, the two stacked glass plates forming two outer surfaces. The two stacked glass plates are totally immersed in the carbon nanotube slurry. The two stacked glass plates are then withdrawn from the carbon nanotube slurry at a constant speed so as to form a respective carbon nanotube slurry layer on each of the two outer surfaces by absorption of the carbon nanotube slurry thereon. The speed at which the glass plates are withdrawn can be expected to inversely impact the resultant slurry layer thickness (i.e., slower withdrawal times should generally yield greater layer thicknesses). It is to be understood that other numbers of glass plates (i.e., not just two thereof) could be treated at a single time, using a similar procedure, and still be within the scope of the present embodiment.

If the glass structure is a glass tube including two ends, and the two ends are defined two respective openings, a method for applying a carbon nanotube slurry layer on the glass plate beneficially includes temporarily sealing one opening to form a sealing end and inverting the sealing end downwards. The glass tube is filled with the carbon nanotube slurry via another opening. The sealing end is then released (i.e., opened yet again) so that the carbon nanotube slurry is drawn out of the glass tube by gravity. As the carbon nanotube slurry is drawn out of the glass tube, a carbon nanotube slurry layer forms on an inner wall of the glass tube by adsorption of the carbon nanotube slurry.

Beneficially, the applying step is performed under conditions wherein the concentration of airborne particulates is less than 1000 mg/m³.

In the step S300, the carbon nanotube slurry layer is dried so that the carbon nanotube slurry layer is fixedly formed on the glass structure.

In the step S400, advantageously, the solidifying step is performed at a temperature of about 320° C. with a duration of about 20 minutes.

An experiment has been carried out using the above-mentioned parameters. A transparent conductive film with a length of about 10 centimeters and a width of about 8 centimeters is formed on the glass structure. The transparent conductive film has been tested. The result indicates that a transparency of the carbon-nanotube-based transparent conductive film is about 70%, and a resistance of the carbon-nanotubes transparent conductive film is less than 100 kilohms (kQ) along a lengthwise direction.

Since carbon nanotubes are used in the method for manufacturing a transparent conductive film according to the present embodiment, manufacturing steps are simple, and materials (e.g., carbon nanotubes, organic carrier) used in the present method are inexpensive.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a transparent conductive film on a glass structure, the method comprising the steps of:
preparing a carbon nanotube slurry;
applying a carbon nanotube slurry layer onto the glass structure;
drying the carbon nanotube slurry layer on the glass structure; and
solidifying the carbon nanotube slurry layer on the glass structure at an approximate temperature of 300˜500° C. and under protection of an inert gas to form the transparent conductive film on the glass structure.

2. The method as claimed in claim 1, wherein the glass structure is a glass plate.

3. The method as claimed in claim 2, wherein a method for applying the carbon nanotube slurry layer on the glass plate comprises the steps of:
providing two stacked glass plates, the two stacked glass plates forming two outer surfaces;
immersing the two stacked glass plates totally in the carbon nanotube slurry; and
withdrawing the two stacked glass plates from the carbon nanotube slurry at a constant speed so as to form a respective carbon nanotube slurry layer on each of the two outer surfaces, each respective carbon nanotube slurry layer being formed by adsorption of the carbon nanotube slurry on a given outer surface.

4. The method as claimed in claim 1, wherein the glass structure is a glass tube including two ends, the two ends defining two respective openings.

5. The method as claimed in claim 4, wherein a method for applying the carbon nanotube slurry layer on the glass tube comprises the steps of:
sealing one opening to form temporarily a sealing end and inverting the sealing end downwards;
filling the glass tube with the carbon nanotube slurry via the other opening; and
releasing the sealing end so that the carbon nanotube slurry is drawn out of the glass tube by gravity, and, thereby, a carbon nanotube slurry layer is formed on an inner wall of the glass tube by absorption thereon of the carbon nanotube slurry.

6. The method as claimed in claim 1, wherein a method for preparing the carbon nanotube slurry comprises the steps of:
preparing an organic carrier, the organic carrier comprising terpineol, dibutyl phthalate, and ethylcellulose;
dispersing carbon nanotubes in dichloroethane so as to form a carbon nanotube suspension;
mixing the carbon nanotube suspension and the organic carrier by ultrasonic dispersion; and
heating the mixture of the carbon nanotube suspension and the organic carrier, so as to form the carbon nanotube slurry.

7. The method as claimed in claim 1, wherein the carbon nanotube slurry is comprised of a plurality of carbon nanotubes, a diameter of the carbon nanotubes is in the approximate range from 1 to 100 nanometers, and a length of the carbon nanotubes is in the approximate range from 1 to 500 microns.

8. The method as claimed in claim 6, wherein a method for preparing the organic carrier comprises the steps of:
dissolving ethyl cellulose and then dibutyl phthalate into terpilenol at an approximate temperature of 80˜110° C.; and
stirring the mixture of ethyl cellulose, dibutyl phthalate and terpilenol for 10 to 25 hours at the temperature of 80˜110° C.

9. The method as claimed in claim 6, wherein percentages of weights of ingredients of the organic carrier are respectively: about 90% of terpilenol, about 5% of ethyl cellulose, and about 5% of dibutyl phthalate.

10. The method as claimed in claim 6, wherein a ratio of carbon nanotubes to dichloroethane is about two grams of carbon nanotubes to about 500 milliliters of dichloroethane; a duration of the dispersing step is about 20 minutes; a weight ratio of carbon nanotubes to the organic carrier is about 15 to 1; a duration of the ultrasonic dispersion is about 30 minutes; and a temperature for the heating step is about 90° C.

11. The method as claimed in claim 1, wherein the applying step is performed under a condition in an environment with a particulate concentration of less than 1000 mg/m³.

12. The method as claimed in claim 1, wherein the solidifying step is performed at a temperature of 320° C. and under a protection of an inert gas, and a duration of the solidifying step is 20 minutes.
